(19) United States
(12) Patent Application Publication
(10) Pub. No.: US 2013/0226559 A1
(43) Pub. Date: Aug. 29, 2013

(54) APPARATUS AND METHOD FOR PROVIDING INTERNET DOCUMENTS BASED ON SUBJECT OF INTEREST TO USER

(71) Applicant: Electronics and Telecommunications Research In, (US)

(72) Inventors: Soo-Jong LIM, Daejeon (KR); Sung-Ho IM, Daejeon (KR); Jong-Ho WON, Daejeon (KR)

(73) Assignee: Electronics and Telecommunications Research Institute, Daejeon-city (KR)

(21) Appl. No.: 13/693,539

(22) Filed: Dec. 4, 2012

(30) Foreign Application Priority Data
Feb. 24, 2012 (KR) 10-2012-0018821

(51) Int. Cl. G06F 17/27

(52) U.S. Cl. CPC G06F 17/2785
USPC 704/9

(57) ABSTRACT

The present invention provides an apparatus for providing Internet documents based on a subject of interest to a user, including an subject reception unit configured to receive information on a subject from a user terminal; a relevant document collection unit configured to collect relevant documents related to the information on the subject of interest using search engines; a similar sentence classification unit configured to extract a core sentence from the relevant documents, calculate similarity of sentences peripheral to the core sentence, and classify sentences similar to the core sentence into similar sentence sets based on the calculated similarity; and a similar sentence providing unit configured to provide the core sentence and the similar sentence sets to the user terminal.

### CROSS-REFERENCE(S) TO RELATED APPLICATIONS

This application claims priority to Korean Patent Application No. 10-2012-0018821, filed on Feb. 24, 2012, which is incorporated herein by reference in its entirety.

### BACKGROUND OF THE INVENTION

1. Field of the Invention

Exemplary embodiments of the present invention relate to an apparatus and method for providing Internet documents based on a subject which is interesting to a user; and, particularly, to an apparatus and method for providing Internet documents based on a subject of interest to a user, which automatically collects pieces of information, corresponding to a given subject for the user, from an Internet document, extracts the pieces of collected information, and groups the pieces of extracted information.

2. Description of Related Art

There are endless pages on information of concern on the Internet. Users may obtain information by transferring a query word on information on desired information into a search engine.

In this Internet environment, a conventional method of extracting information wanted by a user and providing the extracted information may be chiefly divided into a template-based information extraction method and a method of automatically extracting the instance of ontology.

The template-based information extraction method may be divided into a method of extracting information from a standardized page based on wrapper and a method of extracting information from an atypical page by using natural language processing technology. In the wrapper-based extraction method, a target site from which pieces of information, such as the title of a movie, a film director/actor/producer, and movie plot, will be extracted is determined, a wrapper suitable for the target site is developed, and the pieces of information are extracted. In the method of extracting information from an atypical page, only desired information is extracted by analyzing a common text page. The wrapper-based extraction method is problematic in that it inevitably requires cost and time because the wrapper has to be developed considering the characteristics of a site from which information will be extracted and the rule of the wrapper must be modified if the site is changed or information is to be extracted from another site.

The method of automatically extracting the instance of ontology, as disclosed in Korean Patent Registration No. 10-0729103 entitled “Method and apparatus for automatically constructing ontology from non-structure web documents”, is similar to the template-based information extraction method for an atypical page in that an instance corresponding to the concept of ontology is extracted, but may be called a field having a high degree of difficulty in that even a property, that is, one of the elements of ontology, has to be checked.

Both the template-based information extraction method and the method of automatically extracting ontology instance have problems. The first problem is that it is not easy to change the subject of extraction once determined, and the second problem is that the subject of extraction is simple like the field of a DB.

### SUMMARY OF THE INVENTION

An embodiment of the present invention is directed to an apparatus and method for providing Internet documents based on a subject which is interesting to a user, which are capable of extracting only information centered on similar sentences into which the needs of a user are sufficiently incorporated by suggesting only information on a subject of interest to the user when only necessary information is to be extracted from an Internet document.

Another embodiment of the present invention is directed to an apparatus and method for providing Internet documents based on a subject of interest to a user, which are capable of improving the convenience of a search by providing the unit of the extraction of information desired by a user as one or more sets of sentences so that the user can set the range and system of information as he wishes.

Another embodiment of the present invention is directed to an apparatus and method for providing Internet documents based on a subject of interest to a user, which are capable of providing more precise information to a user by clustering similar sentences having similarity based on a core sentence, that is, the subject of information extraction, and taking semantic similarity between the sentences into consideration.

Other objects and advantages of the present invention can be understood by the following description, and become apparent with reference to the embodiments of the present invention. Also, it is obvious to those skilled in the art to which the present invention pertains that the objects and advantages of the present invention can be realized by the means as claimed and combinations thereof.

In accordance with an embodiment of the present invention, an apparatus for providing Internet documents based on a subject of interest to includes a subject reception unit configured to receive information on a subject of interest from a user terminal; a relevant page collection unit configured to collect relevant documents related to the information on the subject of interest using search engines; a similar sentence classification unit configured to extract a core sentence from the relevant documents, determine the similarity of sentences peripheral to the core sentence, and classify sentences similar to the core sentence into similar sentence sets based on the calculated similarity; and a similar sentence providing unit configured to provide the core sentence and similar sentence sets to the user terminal.

The information on the queried subject may be information corresponding to a search word, a query word, or a keyword related to the subject of interest.

The relevant documents collection unit may collect relevant documents by using a meta-search method using open APIs provided by the search engines.

The similar sentence classification unit may include a core sentence determination module configured to extract the core sentence, which is the core of the information on the subject of interest from a plurality of sentences included in the relevant documents.

The similar sentence classification unit may further include a first similarity calculation module configured to calculate the similarity value between the core sentence and each of the peripheral sentences; a relevant sentence determination module configured to determine sentences, each having the similarity value equal to or higher than a preset value, from among the peripheral sentences, as the relevant sentences related to the core sentence; a second similarity calculation module configured to calculate a similarity value between the core sentence and each of the relevant sentences; a similar sentence determination module configured to determine relevant sentences each having the similarity value equal to or higher than a preset value, from among the relevant sentences, as the sentences similar to the core sentence and classify similar sentences into similar sentence sets; and a clustering module configured to group the core sentence and the similar sentence sets.

The similar sentence classification unit may further include a redundant sentence determination module configured to determine whether or not there is a redundant sentence in the clustered core sentence and similar sentence set; and a redundant sentence removal module configured to remove redundant sentences, if, as a result of the determination, it is determined that there is a redundant sentence.

In accordance with another embodiment of the present invention, a method of providing Internet documents based on a subject of interest to a user includes receiving, by an subject reception unit, information on a subject of interest from a user terminal; collecting, by a relevant document collection unit using search engines, relevant documents related to the information on the subject of interest; extracting, by a similar sentence classification unit, a core sentence from the relevant documents; calculating, by the similar sentence classification unit, similarity of sentences peripheral to the core sentence, and classifying sentences similar to the core sentence into similar sentence sets based on the calculated similarity; and providing, by a similar sentence providing unit, the core sentence and the similar sentence sets to the user terminal.

The extracting, by the similar sentence classification unit, the core sentence from the relevant documents may include extracting, by a core sentence determination module, the core sentence, which is the core of the information on the queried subject from a group of sentences included in the relevant documents.

Calculating the similarity between the core sentence and each of the sentences peripheral to the core sentence and extracting the similar sentence sets determined to be similar to the core sentence may include calculating, by a first similarity calculation module, a similarity value between the core sentence and each of the peripheral sentences; determining, by a relevant sentence determination module, sentences each having the similarity value equal to or higher than a preset value, from among the peripheral sentences, as the relevant sentences related to the core sentence; calculating, by a second similarity calculation module, a similarity value between the core sentence and each of the relevant sentences; determining, by a similar sentence determination module, relevant sentences each having a similarity value equal to or higher than a preset value, from among the relevant sentences, as the sentences similar to the core sentence and classifying the similar sentences into similar sentence sets; and clustering, by a clustering module, the core sentence and the similar sentence sets.

The method may further include determining, by a redundant sentence determination module, whether or not there is a redundant sentence in the clustered core sentence and similar sentence sets, after clustering, by a clustering module, the core sentence and the similar sentence sets, and removing, by a redundant sentence removal module, redundant sentences, if, as a result of the determination, it is determined that there is a redundant sentence.

### BRIEF DESCRIPTION OF THE DRAWINGS

FIG. 1 shows the construction of an apparatus for providing Internet documents based on a subject of interest to a user in accordance with an embodiment of the present invention.

FIG. 2 shows a detailed construction of a similar sentence classification unit used in the apparatus for providing Internet documents based on a subject of interest to a user in accordance with an embodiment of the present invention.

FIG. 3 is a flowchart illustrating a method of providing Internet documents based on a subject which is interesting to a user in accordance with an embodiment of the present invention.

FIG. 4 is a flowchart illustrating a method of collecting and extracting similar sentences from relevant documents and clustering the extracted sentences in the method of providing Internet documents based on a subject of interest to a user in accordance with an embodiment of the present invention.

FIG. 5 is a diagram illustrating a method of collecting and extracting similar sentences from relevant documents and clustering the extracted sentences in the method of providing Internet documents based on a subject of interest to a user in accordance with an embodiment of the present invention.

FIG. 6 is a diagram illustrating the results of the collection and extraction of similar sentences from relevant documents in the method of providing Internet documents based on a subject of interest to a user in accordance with an embodiment of the present invention.

FIG. 7 is a diagram illustrating a screen that provides a set of clustered similar sentences to a user terminal in the method of providing Internet documents based on a subject of interest to a user in accordance with an embodiment of the present invention.

### DESCRIPTION OF SPECIFIC EMBODIMENTS

Exemplary embodiments of the present invention will be described below in more detail with reference to the accompanying drawings. The present invention may, however, be embodied in different forms and should not be construed as limited to the embodiments set forth herein. Rather, these embodiments are provided so that this disclosure will be thorough and complete, and will fully convey the scope of the present invention to those skilled in the art. Throughout the disclosure, like reference numerals refer to like parts throughout the various figures and embodiments of the present invention.

An apparatus for providing Internet documents based on a subject of interest to a user in accordance with an embodiment of the present invention is described in detail below with reference to the accompanying drawings.

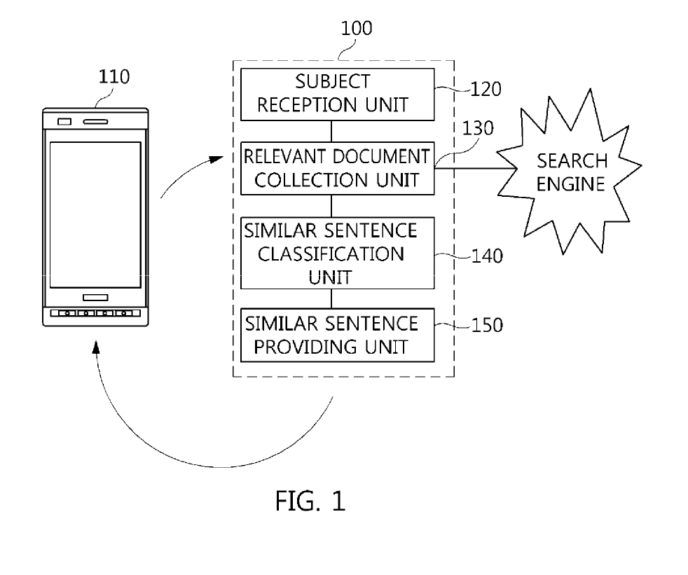

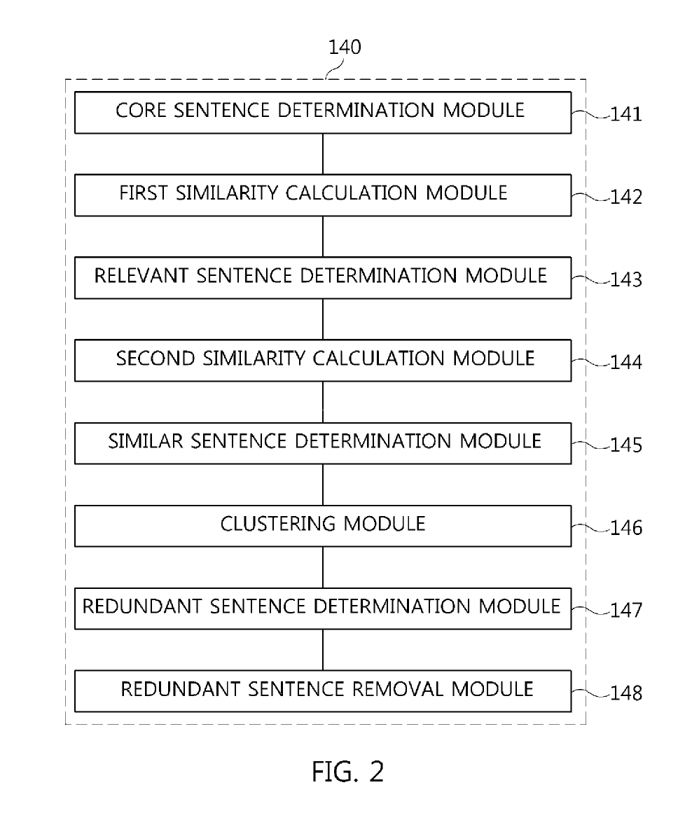

FIG. 1 shows the construction of an apparatus for providing Internet documents based on a subject of interest to a user in accordance with an embodiment of the present invention, and FIG. 2 shows a detailed construction of a similar sentence classification unit used in the apparatus for providing Internet pages based on a subject of interest to a user in accordance with an embodiment of the present invention.

As shown in FIGS. 1 and 2, the apparatus 100 for providing Internet documents in accordance with the present invention chiefly includes a subject reception unit 120, a relevant document collection unit 130, a similar sentence classification unit 140, and a similar sentence providing unit 150.

The subject reception unit 120 receives information on a subject of interest from a user terminal 110. Here, the information on the subject of interest refers to information corresponding to a search word, a query word, or a keyword related to the subject of interest, but it may be information system information including a hierarchical structure.

The relevant document collection unit 130 collects relevant documents related to the information on the subject of interest using search engines. The relevant document collection unit 130 collects relevant documents by using open APIs provided by search engines. The search engine refers to software that helps information be easily searched for from the Internet. The time taken for a search is different depending on the selection of a search word and the designation of a proper search condition by a user. A search method includes a search method of a user directly inputting a keyword, that is, a search word, and a category search method of narrowing a range in such a manner that a user selects desired items from several items proposed by a search engine. First, in a word-oriented searching, when contents to be searched for are inputted, the contents are displayed in the form of a web page by searching a DB from a search site for given contents. Second, in subject-oriented searching, information on the Internet is searched for by narrowing pieces of information from a wide range. Third, in a meta-search engine method, a search word or a keyword inputted by a user is requested from large search engines on the Internet, and the results of the request are retrieved. The relevant document collection unit 130 of the present invention collects relevant documents by using the meta-search method. The meta-search method is described in detail below. When a user sends a keyword search query to a server, the server sends the query to the previously designated search engines, receives the results of the search from the search engines, and shows the results to the user at once. Query is transmitted to search engines in real time depending on the content to be searched for, or pieces of content are previously collected from search engines, the pieces of content are databased, and the results of the query are shown to a user only when the query is received from the user.

The similar sentence classification unit 140 extracts relevant sentences related to the information on a subject of interest from the collected relevant documents and groups the extracted relevant sentences based on similarity. That is, the similar sentence classification unit 140 extracts a core sentence from the collected relevant documents, calculates similarity of peripheral sentences on the basis of the core sentence, and classifies similar sentences determined to be similar to the core sentence based on the calculated similarity into similar sentence sets.

To this end, the similar sentence classification unit 140 includes a core sentence determination module 141, a first similarity calculation module 142, a relevant sentence determination module 143, a second similarity calculation module 144, a similar sentence determination module 145, a clustering module 146, a redundant sentence determination module 147, and a redundant sentence removal module 148.

The core sentence determination module 141 extracts the core sentence from a plurality of sentences including the relevant documents. The core sentence refers to a sentence having a kernel meaning, that is, the information on the subject of interest, in the relevant sentences. In order to extract the core sentence, a weight calculation method may be used. The weight calculation method is known in the art, and thus a detailed description thereof is omitted.

The first similarity calculation module 142 calculates a similarity value between the core sentence and sentences peripheral to the core sentence. That is, the first similarity calculation module 142 calculates similarity between the core sentence having the information on the subject of interest and sentences peripheral to the core sentence, that is, sentences placed before and behind the core sentence.

The relevant sentence determination module 143 determines sentences each having a similarity value equal to or higher than a preset value, from among the peripheral sentences, as the relevant sentences related to the core sentence.

The second similarity calculation module 144 calculates a similarity value between the core sentence and each of the relevant sentences. That is, the first similarity calculation module 142 compares the core sentence having the information on the subject of interest with each of the relevant sentences in relation to similarity.

The similar sentence determination module 145 determines relevant sentences, each having the similarity value equal to or higher than a preset value, from among the relevant sentences, as the similar sentences similar to the core sentence and classifies the determined similar sentences into similar sentence sets.

The clustering module 146 groups the core sentence and the similar sentence sets. Here, the term ‘clustering’ corresponds to a tendency for similar or related items to be bound and stored, and is a concept capable of storing more information and also increasing the short-term capacity of the memory. Accordingly, the clustering module 146 can group the core sentence and the similar sentences based on a system inputted by a user or similarity and obtain sentence-based classification results by using a clustering method of classifying data into several groups on the basis of a concept, such as similarity.

The redundant sentence determination module 147 determines whether or not there is a redundant sentence in the clustered core sentence and similar sentence sets.

The redundant sentence removal module 148 removes redundant sentences if, as a result of the determination, it is determined that there is a redundant sentence.

The similar sentence providing unit 150 provides the core sentence and similar sentence sets to the user terminal 110 and may store the core sentence and similar sentence sets at the request of a user. That is, the similar sentence providing unit 150 presents the final results, obtained by removing redundant sentences from the sentence-based classification results obtained from the clustered core sentence and similar sentence sets, to the user.

A method of providing Internet documents based on a subject of interest to a user in accordance with an embodiment of the present invention is described below with reference to the accompanying drawings.

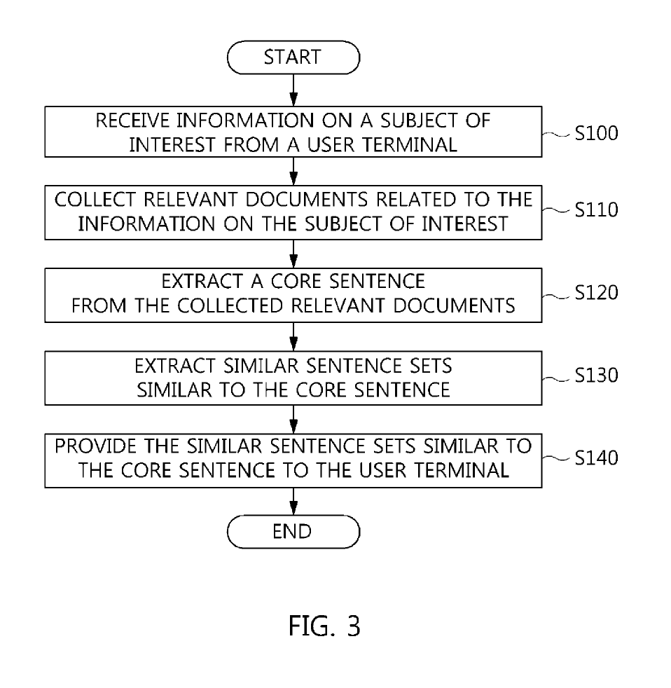

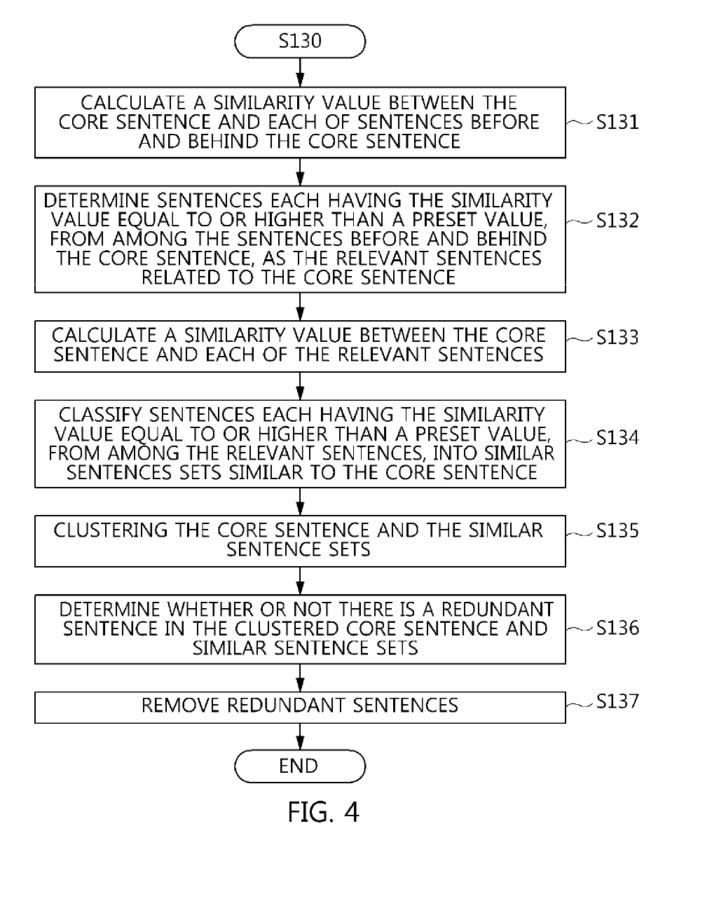

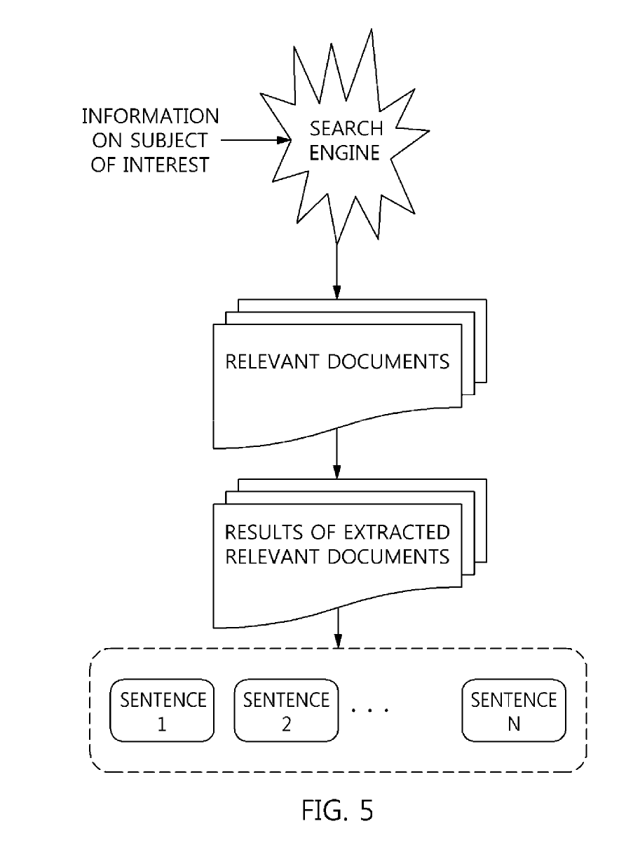

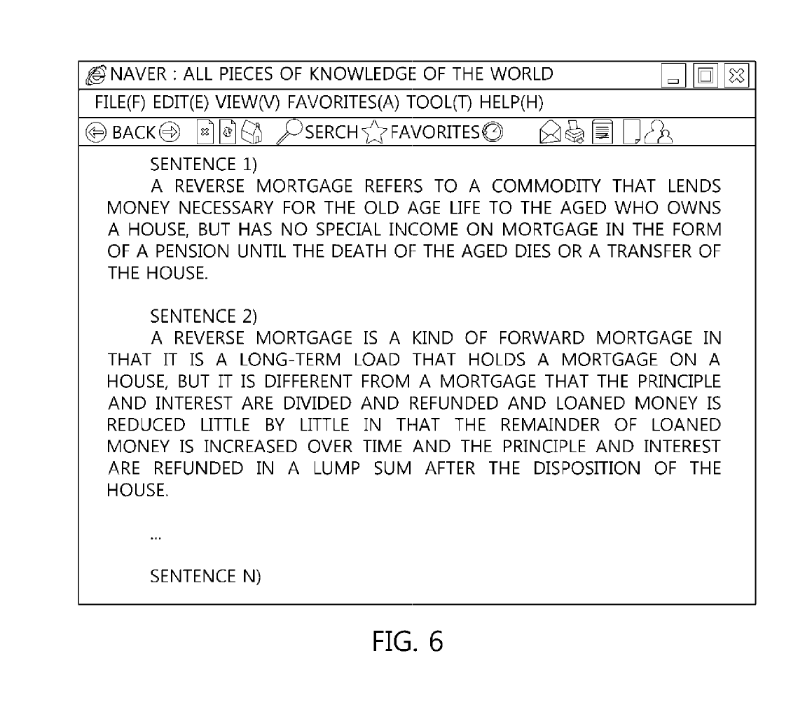

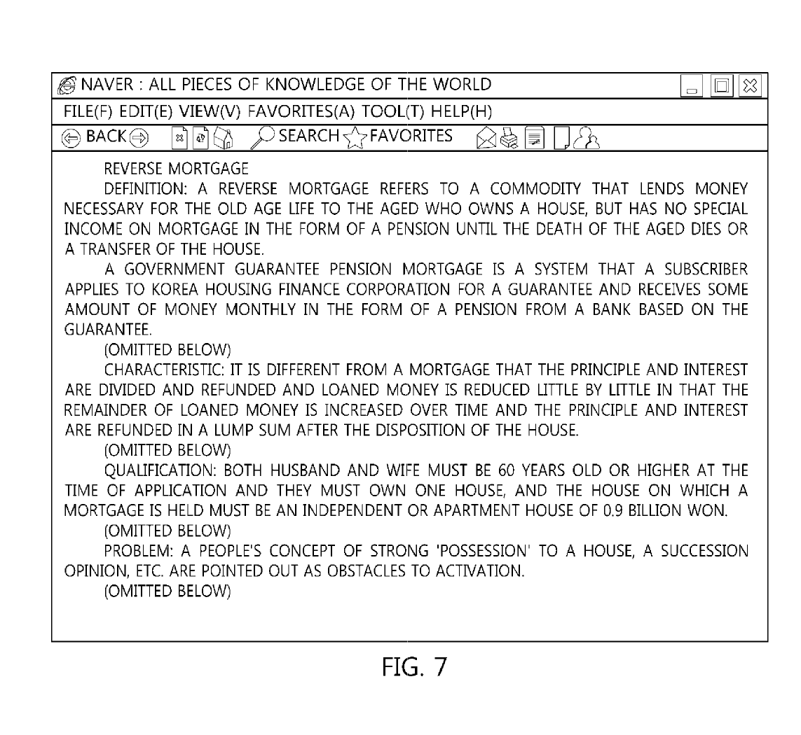

FIG. 3 is a flowchart illustrating a method of providing Internet documents based on a subject of interest to a user in accordance with an embodiment of the present invention, FIG. 4 is a flowchart illustrating a method of collecting and extracting similar sentences from relevant documents and clustering the extracted sentences in the method of providing Internet documents based on a subject of interest to a user in accordance with an embodiment of the present invention, FIG. 5 is a diagram illustrating a method of collecting and extracting similar sentences from relevant documents and clustering the extracted sentences in the method of providing Internet documents based on a subject of interest to a user in accordance with an embodiment of the present invention, FIG. 6 is a diagram illustrating the results of the collection and extraction of similar sentences from relevant documents in the method of providing Internet documents based on a subject of interest to a user in accordance with an embodiment of the present invention, and FIG. 7 is a diagram illustrating a screen that provides a set of clustered similar sentences to a user terminal in the method of providing Internet documents based on a subject of interest to a user in accordance with an embodiment of the present invention.

As shown in FIG. 3, in the method of providing Internet documents in accordance with the present invention, first, the subject reception unit 120 receives information on a subject of interest from the user terminal 110 at step S100. Here, the information on the subject of interest refers to information corresponding to a search word, a query word, or a keyword related to the subject of interest, but it may be information system information including a hierarchical structure. Meanwhile, in the present invention, it is assumed that the information on the subject of interest is ‘reverse mortgage’.

Next, the relevant document collection unit 130 using search engines collects relevant documents related to the information on the subject at step S110. Here, the relevant document collection unit 130 collects a plurality of the relevant documents related to the ‘reverse mortgage’, that is, the information on the subject of interest, by using open APIs provided by the search engines.

Next, the similar sentence classification unit 140 extracts a core sentence from the collected relevant documents at step S120. Here, the similar sentence classification unit 140 extracts the core sentence from a plurality of sentences 1 . . . N extracted from the relevant documents, as shown in FIG. 5. In the present invention, the core sentence may be the sentence 1 including the ‘reverse mortgage’, that is, the information on the subject of interest, as shown in FIG. 6.

Next, the similar sentence classification unit 140 calculates similarity between the core sentence and sentences peripheral to the core sentence and classifies sentences similar to the core sentence into similar sentence sets based on the calculated similarity at step S130. This process is described in detail with reference to FIG. 4. First, the first similarity calculation module 142 calculates a similarity value between the core sentence and each of the sentences peripheral to the core sentence at step S131. That is, the first similarity calculation module 142 compares the core sentence having the information on the subject of interest with each of the relevant sentences in relation to similarity. Next, the relevant sentence determination module 143 determines sentences each having the similarity value equal to or higher than a preset value, from among the peripheral sentences, as the relevant sentences related to the core sentence at step S132. Next, the second similarity calculation module 144 calculates a similarity value between the core sentence and each of the relevant sentences at step S133. That is, the first similarity calculation module 142 compares the core sentence having the information on the subject of interest with each of the relevant sentences in relation to similarity. Next, the similar sentence determination module 145 determines relevant sentences, each having the similarity value equal to or higher than a preset value, from among the relevant sentences, as similar sentences similar to the core sentence and classifies the determined similar sentences into similar sentence sets at step S134. Next, the clustering module 146 groups the core sentence and the similar sentence sets at step S135. That is, the clustering module 146 can group the core sentence and the similar sentences based on a system inputted by a user or similarity and obtain sentence-based classification results by using a clustering method of classifying data into several groups on the basis of a concept, such as similarity. Next, the redundant sentence determination module 147 determines whether or not there is a redundant sentence in the clustered core sentence and similar sentence sets at step S136. Next, the redundant sentence removal module 148 removes redundant sentences if, as a result of the determination, it is determined that there is a redundant sentence at step S137.

Finally, the similar sentence providing unit 150 provides the core sentence and similar sentence sets to the user terminal 110 and may store the core sentence and similar sentence sets at the request of a user at step S140. That is, the similar sentence providing unit 150 presents the final results, obtained by removing redundant sentences from the sentence-based classification results obtained from the clustered core sentence and similar sentence sets, to the user, as shown in FIG. 7.

As described above, the apparatus and method for providing Internet documents based on a subject of interest to a user in accordance with the present invention can extract only information centered on similar sentences into which the needs of a user are sufficiently incorporated and provide systematic and precise information to the user by presenting only information on a subject of interest to a user when extracting only necessary information from Internet documents.

Furthermore, the convenience of a search can be improved because the unit of the extraction of information desired by a user is provided as one or more sets of sentences so that the user can set the range and system of information as he wishes.

Furthermore, more precise information can be provided to a user because similar sentences having similarity based on a core sentence, that is, the subject of information extraction, are clustered and semantic similarity between the sentences is taken into consideration.

While the present invention has been described with respect to the specific embodiments, it will be apparent to those skilled in the art that various changes and modifications may be made without departing from the spirit and scope of the invention as defined in the following claims.

What is claimed is:

1. An apparatus for providing Internet documents based on a subject of interest to a user, the apparatus comprising:
a subject reception unit configured to receive information on a subject of interest from a user terminal;
a relevant document collection unit configured to collect relevant documents related to the information on the subject using search engines;
a similar sentence classification unit configured to extract a core sentence from the relevant documents, calculate similarity of sentences peripheral to the core sentence, and classify sentences similar to the core sentence into similar sentence sets based on the calculated similarity; and
a similar sentence providing unit configured to provide the core sentence and the similar sentence sets to the user terminal.

2. The apparatus of claim 1, wherein the information on the subject of interest is information corresponding to a search word, a query word, or a keyword related to the subject of interest.

3. The apparatus of claim 1, wherein the relevant document collection unit collects the relevant documents by using a meta-search method using an open API provided by the search engines.

4. The apparatus of claim 1, wherein the similar sentence classification unit comprises a core sentence determination module configured to extract the core sentence which is a core of the information on the subject of interest from a plurality of sentences included in the relevant documents.

5. The apparatus of claim 4, wherein the similar sentence classification unit further comprises:
a first similarity calculation module configured to calculate a similarity value between the core sentence and each of the peripheral sentences;
a relevant sentence determination module configured to determine sentences each having the similarity value equal to or higher than a preset value, from among the peripheral sentences, as the relevant sentences related to the core sentence;
a second similarity calculation module configured to calculate a similarity value between the core sentence and each of the relevant sentences;
a similar sentence determination module configured to determine relevant sentences each having the similarity value equal to or higher than a preset value, from among the relevant sentences, as the sentences similar to the core sentence and classify the similar sentences into similar sentence sets; and
a clustering module configured to group the core sentence and the similar sentence sets.

6. The apparatus of claim 5, wherein the similar sentence classification unit further comprises:
a redundant sentence determination module configured to determine whether or not there is a redundant sentence in the clustered core sentence and similar sentence set; and
a redundant sentence removal module configured to remove redundant sentences, if, as a result of the determination, it is determined that there is a redundant sentence.

7. A method of providing Internet documents based on a subject of interest to a user, comprising:
receiving, by a subject reception unit, information on a subject of interest from a user terminal;
collecting, by a relevant document collection unit using search engines, relevant documents related to the information on the subject of interest;
extracting, by a similar sentence classification unit, a core sentence from the relevant documents;
calculating, by the similar sentence classification unit, similarity of sentences peripheral to the core sentence, and classifying sentences similar to the core sentence into similar sentence sets based on the calculated similarity; and
providing, by a similar sentence providing unit, the core sentence and the similar sentence sets to the user terminal.

8. The method of claim 7, wherein the extracting, by the similar sentence classification unit, the core sentence from the relevant documents comprises extracting, by a core sentence determination module, the core sentence, which is the core of the information on the queried subject from a group of sentences included in the relevant documents.

9. The method of claim 7, wherein the classifying sentences similar to the core sentence into similar sentence sets based on the calculated similarity comprises:
calculating, by a first similarity calculation module, a similarity value between the core sentence and each of the peripheral sentences;
determining, by a relevant sentence determination module, sentences each having the similarity value equal to or higher than a preset value, from among the peripheral sentences, as the relevant sentences related to the core sentence;
calculating, by a second similarity calculation module, a similarity value between the core sentence and each of the relevant sentences;
determining, by a similar sentence determination module, relevant sentences each having the similarity value equal to or higher than a preset value, from among the relevant sentences, as the sentences similar to the core sentence and classifying the similar sentences into similar sentence sets; and
clustering, by a clustering module, the core sentence and the similar sentence sets.

10. The method of claim 9, further comprising:
determining, by a redundant sentence determination module, whether or not there is a redundant sentence in the clustered core sentence and similar sentence sets, after clustering, by a clustering module, the core sentence and the similar sentence sets; and
removing, by a redundant sentence removal module, redundant sentences, if, as a result of the determination, it is determined that there is a redundant sentence.
